(19) United States
(12) Patent Application Publication
(10) Pub. No.: US 2026/0001184 A1
(43) Pub. Date: Jan. 1, 2026

(54) MILL CALIBRATION WITH SINGLE SCAN

(71) Applicant: James R. Glidewell Dental Ceramics, Inc., Newport Beach, CA (US)

(72) Inventors: Babak Manafighazani, Rancho Santa Margarita, CA (US); Santosh Gaikwad, Irvine, CA (US); Moses Zuniga, Tustin, CA (US); Kunal Patil, Foothill Ranch, CA (US)

(73) Assignee: James R. Glidewell Dental Ceramics, Inc., Newport Beach, CA (US)

(21) Appl. No.: 18/759,601

(22) Filed: Jun. 28, 2024

(51) Int. Cl. B23Q 15/12; B23C 9/00

(52) U.S. Cl. CPC B23Q 15/12; B23C 9/00; B23C 2250/00

(57) ABSTRACT

A computer-implemented system, method, and medium of automated milling machine calibration includes receiving a 3D virtual calibration design comprising one or more designed indented regions and a designed curved region; milling the 3D virtual calibration design into a physical block to provide a 3D physical milled calibration block; receiving a 3D virtual calibration scan block of the 3D physical milled calibration block; and determining one or more calibration parameters from the 3D virtual calibration scan block.

### BACKGROUND

CNC machines used in milling operations can be subject to misalignment of one or more milling components. Repeated milling can involve vibrations and resistive forces that can cause misalignment over a period of time. The misalignment can affect the quality of any milled object. Misalignment can be particularly problematic when milling objects requiring fine detail and precision, such as dental prosthesis such as crowns, inlays, etc. Misalignments can cause product defects and increase waste and reduce production.

Manual alignment can be time consuming. Manual alignment can require an operator to track and identify a milling machine in need of calibration, record calibration data, measure manually with a micrometer, check for tolerances, and record values, etc. Accordingly, calibration of milling machines can be challenging.

### SUMMARY

Disclosed is a computer-implemented method of automated milling machine calibration, including: receiving a 3D virtual calibration design having one or more designed indented regions and a designed curved region; milling the 3D virtual calibration design into a physical block to provide a 3D physical milled calibration block; receiving a 3D virtual calibration scan block of the 3D physical milled calibration block; and determining one or more calibration parameters from the 3D virtual calibration scan block.

Disclosed is a non-transitory computer readable medium storing executable computer program instructions to provide automated milling machine calibration, the computer program instructions including instructions for: receiving a 3D virtual calibration design having one or more designed indented regions and a designed curved region; milling the 3D virtual calibration design into a physical block to provide a 3D physical milled calibration block; receiving a 3D virtual calibration scan block of the 3D physical milled calibration block; and determining one or more calibration parameters from the 3D virtual calibration scan block.

Disclosed is a system for automated milling machine calibration, the system including: a processor; and a non-transitory computer-readable storage medium including instructions executable by the processor to perform steps including: receiving a 3D virtual calibration design having one or more designed indented regions and a designed curved region; milling the 3D virtual calibration design into a physical block to provide a 3D physical milled calibration block; receiving a 3D virtual calibration scan block of the 3D physical milled calibration block; and determining one or more calibration parameters from the 3D virtual calibration scan block.

### BRIEF DESCRIPTION OF THE DRAWINGS

FIG. 1 is a diagram illustrating an overview of automated rotary axis calibration with a single scan in some embodiments.

FIG. 2 is a 3D perspective view of a 3D virtual calibration design in some embodiments.

FIG. 3(a) through FIG. 3(c) are various views illustrating a 3D physical block in some embodiments.

FIGS. 4(a) and 4(b) are a front view and a side view, respectively, of a milling machine with a mounted physical block in some embodiments.

FIG. 5(a) is a perspective view of an illustration of a physical block prior to milling a first surface region in some embodiments. FIG. 5(b) is a side view of a milling machine while milling the first surface region in some embodiments. FIG. 5(c) is a perspective view of an illustration of a physical block after milling the first surface region.

FIG. 6(a) is a front view of an illustration of a physical block after milling one or more indented regions. FIG. 6(b) is a side cross section view of an illustration of a physical block after milling one or more milled indented regions.

FIG. 7 is side view of a milling machine while milling a curved region in the physical block in some embodiments.

FIG. 8 is a perspective view of a milled physical block in some embodiments.

FIG. 9 is a perspective view illustrating a 3D scanned model of a milled calibration block in some embodiments.

FIG. 10 is a cross section side view illustration of a 3D scanned model of a milled calibration block in some embodiments.

FIG. 11(a) through 11(d) are front views illustrating determining an calibration parameters in some embodiments.

FIG. 12 is a flowchart in some embodiments.

FIG. 13 is a diagram illustrating a computing environment in some embodiments.

### DETAILED DESCRIPTION

For purposes of this description, certain aspects, advantages, and novel features of the embodiments of this disclosure are described herein. The disclosed methods, apparatus, and systems should not be construed as being limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved.

Although the operations of some of the disclosed embodiments are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. The actual operations that correspond to these terms may vary depending on the particular implementation and are readily discernible by one of ordinary skill in the art.

As used in this application and in the claims, the singular forms “a,” “an,” and “the” include the plural forms unless the context clearly dictates otherwise. Additionally, the term “includes” means “comprises.” Further, the terms “coupled” and “associated” generally mean electrically, electromagnetically, and/or physically (e.g., mechanically or chemically) coupled or linked and does not exclude the presence of intermediate elements between the coupled or associated items absent specific contrary language.

In some examples, values, procedures, or apparatus may be referred to as “lowest,” “best,” “minimum,” or the like. It will be appreciated that such descriptions are intended to indicate that a selection among many alternatives can be made, and such selections need not be better, smaller, or otherwise preferable to other selections.

In the following description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

Some embodiments can include a computer-implemented method of automated milling machine calibration. The computer-implemented method can include receiving a calibration alert from a milling machine, performing automated calibration on the milling machine to determine one or more offsets, and automatically update milling production instructions with the one or more offsets.

Some embodiments can include a computer-implemented method, system, and/or medium of automated milling machine calibration. The method, system, and/or medium can include receiving a 3D virtual calibration design having one or more designed indented regions and a designed curved region; milling the 3D virtual calibration design into a physical block to provide a 3D physical milled calibration block; receiving a 3D virtual calibration scan block of the 3D physical milled calibration block; and determining one or more calibration parameters from the 3D virtual calibration scan block.

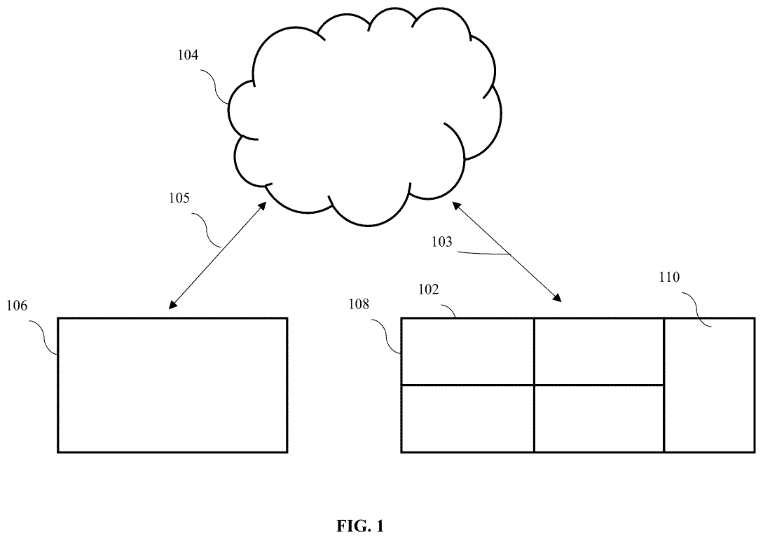

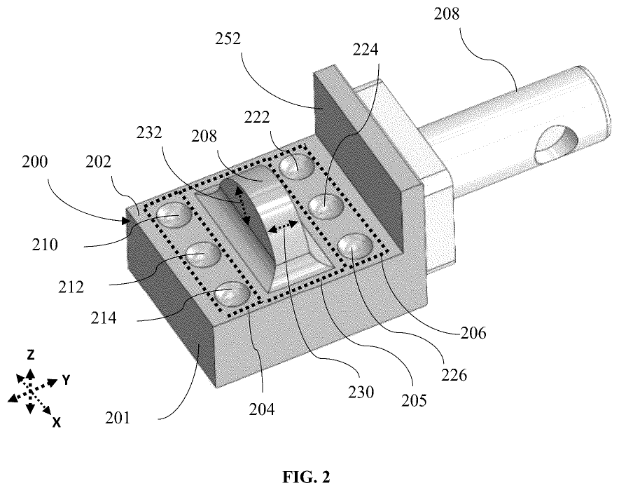

FIG. 1 illustrates an example of automated milling machine calibration in some embodiments. One or more milling machines 108 can be located in a dental laboratory, dental office, or any other facility, and be in communication 103 with one or more computing systems in a cloud computing environment 104 or other networked environment. The cloud computing environment 104 can also be in communication 105 with and one or more scanners 106, such as an optical scanner such as a Polyga C504 scanner and/or an intraoral scanner_available commercially off the shelf. Any other scanner can be used. The cloud computing environment 104 can be of any type, including, but not limited to Amazon AWS, for example. Any other type of cloud computing environment can be used. The one or more milling machines 108 can in some embodiments be dental milling machines used to mill dental prosthesis such as crowns, inlays, etc. Communication can be performed over the internet, through a wireless or cellphone network, or by connected networks. In some embodiments, one or more features can be performed in the cloud computing environment 104. Alternatively, in some embodiments, one or more features can be performed on a computer system that is in communication with the scanner and the one or more milling machines.

In some embodiments, the one or more milling machines can have at least 3 axes, such as a 4 axis Computer Numerical Control (“CNC”) machine. In some embodiments, the milling machine can be any dental mill used to mill dental restorations, including but not limited to those found in dental offices, dental laboratories, or other milling facilities. In some embodiments, the mill can be part of a milling system, such as the milling system described in U.S. Pat. No. 10,838,398, the entirety of which is incorporated by reference herein. In some embodiments, the milling system can include one or more dental milling machines 108 also include a dental block repository 110 of dental blanks used to mill the dental prosthesis. In some embodiments, milling machines can include, for example FastMill™ by Glidewell Laboratories, or other type of milling machine suitable for shaping/milling dental restorations. One example of a milling machine in some embodiments is described in U.S. Pat. No. 10,133,244, which is incorporated by reference herein in its entirety.

During production, the one more dental milling machines 108 can receive requests to mill dental prostheses such crowns, inlays, etc. The one or more dental milling machines can obtain and shape a dental block from the dental block repository 110 for each request during production. Alternatively, the dental blocks can be loaded manually from the dental block repository 110.

In some embodiments, the computer-implemented method can receive a calibration alert from a milling machine. The calibration alert can be triggered by one or more conditions that require the milling machine to be calibrated. For example, in some embodiments, the calibration alert can be triggered when the milling machine reaches or passes a threshold operation value. In some embodiments, the threshold operation value can be based on a user-configurable time period. For example, the calibration alert can be triggered when the milling machine has been operating for a set period of time, which can be configured by the user. In some embodiments, the threshold operation value can be 24 hours. Other user-configurable time periods can be used. In some embodiments, the threshold operation value can be a number of operations, such as a number of dental prosthesis milled and/or operations performed. The calibration alert can be triggered when the milling machine reaches or passes the threshold operation value in some embodiments. In some embodiments, the calibration alert can be triggered manually by an operator or mill user.

Upon reaching the threshold operation value or upon initiation of manual calibration, the milling machine can raise the calibration alert. For example, in some embodiments, milling machine 102 can generate a calibration alert. In some embodiments, the calibration alert can be communicated 103 to the cloud computing architecture or to a connected computer.

In some embodiments, the computer-implemented method can receive the calibration alert from the milling machine and perform calibration on the milling machine. In some embodiments, performing calibration on the milling machine can include milling a 3D virtual calibration design into a physical block with the milling machine that generated the calibration alert.

In some embodiments, the 3D virtual calibration design can include one or more features to calibrate the milling machine. In some embodiments, the 3D virtual calibration design can include a designed first surface region. In some embodiments, the designed first surface region can be in the X-Y plane and have a depth along an Z-axis. In some embodiments, the designed first surface region can include one or more designed indented regions extending into the designed first surface region, and a designed curved region extending from the designed first surface region.

In some embodiments, the number of designed indented regions can be at least three, preferably six designed indented regions. In some embodiments, the designed indented regions can be spaced equally apart from one another.

In some embodiments, the dimensions of each of the one or more designed indented regions can have the same dimensions in the 3D virtual calibration design. For example, each of the one or more designed indented regions can have the same length, width and/or depth. In some embodiments, the one or more designed indented regions can have the same radius value and/or same depth value.

In some embodiments, the one or more designed indented regions can have a shape matching at least a portion of a tip of a grinding tool in a mill, for example. In some embodiments, the one or more designed indented regions can be at least partially or entirely spherical in shape. In some embodiments, the one or more designed intended regions can be half spherical in shape. In some embodiments, each of the at least partially/entirely spherical regions can have the same radius value and/or the same depth value in the 3D virtual calibration design. Any suitable spherical region radius value and any suitable depth value can be used. In some embodiments, the radius value can preferably be designed to be ½ the diameter of the grinding/milling tool. In some embodiments, the depth value can be designed to be ½ the diameter of the grinding/milling tool. In some embodiments, the number of at least partly spherical regions can be at least three, preferably six at least partially spherical regions.

In some embodiments, the one or more designed indented regions can be designed to have the same depth value. In the case where the designed indented regions are spherical or at least partially spherical regions, the spherical region depth value can correspond to the spherical region radius value.

In some embodiments, the designed first surface region can include three sections. The three sections can include a first section, a middle section, and a second section. In some embodiments, the first section of the designed first surface region can be a region on the designed first surface region furthest away from a mandrel. In some embodiments, the first section can include a row of one more designed indented regions. In some embodiments, the first section can include three designed indented surface regions. In some embodiments, the designed indented regions can be arranged in a row across the first section, extending along a width corresponding to the X-axis of the 3D virtual calibration design model on the designed first surface region. The designed indented regions can be arranged so that the centers of the designed indented regions align along the width of the designed first surface region and when connected form a line parallel to X-axis. In some embodiments, the number of the designed indented regions in the first section can be three. However, more or fewer designed indented regions can be used.

In some embodiments, the second section of the designed first surface region can be a region on the designed first surface region closest to the mandrel. In some embodiments, the second section can include a row of one more designed indented regions. In some embodiments, the second section can include three designed indented surface regions. In some embodiments, the designed indented regions can be arranged in a row across the second section, extending along a width corresponding to the X-axis of the 3D virtual calibration design model on the designed first surface region. The designed indented regions can be arranged so that the centers of the designed indented regions align along the width of the designed first surface region and when connected form a line parallel to X-axis. In some embodiments, the number of the designed indented regions in the second section can be three. However, more or fewer designed indented regions can be used.

In some embodiments, the middle section can be defined by a designed curved region arranged on and extending from the designed first surface region between the first section and the second section. In some embodiments, the designed curved region can be substantially cylindrical, having a radius defined from a center Y-axis of the 3D virtual calibration design and a height along the Y-axis. In some embodiments, the first surface region is a substantially flat surface, except where the half spheres and the curved region are located in the 3D virtual calibration design. In some embodiments, the curved region can have a radius value of approximately 5 mm and a height of approximately 4 mm. However, any suitable radius and height can be used.

Some embodiments can include a second surface region connected to the mandrel and non-parallel with the first surface region. In some embodiments, the second surface region can be perpendicular to the first surface region. In some embodiments, the middle section can be between the first section and the second section, and the second section can be between the middle section and the second surface region. In some embodiments, the second surface region can extend be ½ the depth of the block (in the Z direction). In some embodiments, the second surface region width can extend along the width of the block (in the X-direction). In some embodiments, the second surface region be in the X-Z plane. In some embodiments, the height of the second surface region (in the Y-direction) can be any suitable value. In some embodiments, the height of the second surface region in the Y-direction can be 2 mm. Other suitable values for the second surface region can be used.

FIG. 2 illustrates one example of a 3D virtual calibration design 200 in a virtual block 201 in some embodiments. The 3D virtual calibration design 200 includes designed first surface region 202. The designed first surface region 202 can include one or more designed indented regions such as indented region 210, indented region 212, indented region 214, indented region 222, indented region 224, indented region 226, as well as a curved region such as curved region 208. In some embodiments, the 3D virtual calibration design can also include second surface region 252 attached to mandrel 208.

The designed first surface region 202 can include first section 204, middle section 205, and second section 206. The first section 204 is furthest from mandrel 208, and the second section 206 is closest to the mandrel 208. The first section 204 includes three designed indented regions 210, 212, and 214, the middle section 205 includes the curved region 208, and the second section 206 includes indented regions 222, 224, and 226. The indented regions in the first section 204 can be designed to have the same depth and with centers such that when connected, the connecting line is parallel to the X-axis. Similarly, the indented regions in the second section 206 can be designed to have the same depth and with centers such that when connected, the connecting line is parallel to the X-axis. The curved region 208 can be substantially cylindrical (½ cylinder) in shape, and can be designed to extend out from the designed first surface 202.

In some embodiments, the centers of each of the designed indented regions in the first section can be the same distance (height) from the bottom of the virtual block along the Y axis. The bottom of the virtual block can in some embodiments be the surface of the virtual block that attaches to the mandrel. In some embodiments, the distance of each of the centers of the designed indented regions in the first section can be 16 mm from the bottom surface of the virtual block along the Y axis. Other suitable distances can be used.

In some embodiments, the center of the designed indented region in the middle of the first section can be centered in the middle of the virtual block along its width (X axis), and the centers of its neighboring designed indented regions in the first section can be equally spaced on either side along the X axis. In some embodiments, the centers of the designed indented regions in the first section can be spaced 5 mm apart along the X direction from their neighbor. Other suitable distances can be used.

In some embodiments, the centers of each of the designed indented regions in the second section can be the same distance (height) from the bottom of the virtual block along the Y axis. The bottom of the virtual block can in some embodiments be the surface of the virtual block that attaches to the mandrel. In some embodiments, the distance of each of the centers of the designed indented regions in the second section can be 5 mm from the bottom surface of the virtual block along the Y axis. Other suitable distances can be used.

In some embodiments, the center of the designed indented region in the middle of the second section can be centered in the middle of the virtual block along its width (X axis), and the centers of its neighbor designed indented regions in the second section can be equally spaced on either side along the X axis. In some embodiments, the centers of designed indented regions in the first section can be spaced 5 mm apart along the X direction from their neighbor. Other suitable distances can be used.

For example, in FIG. 2, the centers of designed indented region 210, designed indented region 212, and designed indented region 214 can be spaced the same distance from the bottom of virtual block 201 along the Y axis. The center of the middle designed indented region 212 can be centered in the middle along the X axis. The centers of the designed indented region 210 and the designed indented region 214 can be equally spaced from the center of the designed indented region 212 along the X axis.

Similarly, in the second section, the centers of designed indented region 222, designed indented region 224, and designed indented region 226 can be spaced the same distance from the bottom of virtual block 201 along the Y axis. The center of the middle designed indented region 224 can be centered along the X axis. The centers of the designed indented region 222 and the designed indented region 226 can be equally spaced from the center of the designed indented region 212 along the X axis.

The curved region 208 can include a curved region height 230 along the Y-axis and a curved region radius 232 from the center of the 3D virtual calibration design Y-axis. In some embodiments, any suitable value for the curved region height and radius can be used. In some embodiments, the curved region radius 232 can be, for example, in the range from 5.0 mm to 6.0 mm, with the preferable radius of 5 mm, and the curved region height 230 can be 4 mm. However, any other values for the curved region radius 232 and curved region height 230 can be used. In some embodiments, the curved region 208 can be half of a cylindrical.

In some embodiments, performing calibration on the milling machine can include loading a calibration routine generated from the 3D virtual calibration design via a CAD/CAM process into the milling machine. In some embodiments, the calibration routine can be loaded from the cloud computing system or a connected computer. In some embodiments, the calibration routine can include milling instructions such as G code or other milling instructions generated from the CAD/CAM process.

In some embodiments, performing calibration on the milling machine can include loading a physical block into the milling machine. In an automated milling system, this can include automatically retrieving a physical block (also known as a blank) from the dental block repository or other location where physical blocks can be stored. Alternatively, the physical block can be loaded manually into the milling machine.

The physical block can be made of any material suitable for fabricating dental prosthesis such as crowns, inlays, etc., In some embodiments, the physical block can be made of cubic zirconia. Preform body materials comprising hardness values within a desirable range may include metals, such as cobalt chrome, glass and glass ceramics, such as lithium silicate and lithium disilicate, and ceramics, including sintered ceramics comprising alumina and zirconia. Dental restoration materials, including but not limited to commercially available dental glass, glass ceramic or ceramic, or combinations thereof, may be used for making the machinable preforms described herein. Ceramic materials may comprise zirconia, alumina, yttria, hafnium oxide, tantalum oxide, titanium oxide, niobium oxide and mixtures thereof. Zirconia ceramic materials include materials comprised predominantly of zirconia, including those materials in which zirconia is present in an amount of about 85% to about 100% weight percent of the ceramic material. Zirconia ceramics may comprise zirconia, stabilized zirconia, such as tetragonal, stabilized zirconia, and mixtures thereof. Yttria-stabilized zirconia may comprise about 3 mol % to about 6 mol % yttria-stabilized zirconia, or about 2 mol % to about 7 mol % yttria-stabilized zirconia. Examples of stabilized zirconia suitable for use herein include, but are not limited to, yttria-stabilized zirconia commercially available from (for example, through Tosoh USA, as TZ-3Y grades). Methods form making dental ceramics also suitable for use herein may be found in commonly owned U.S. Pat. No. 8,298,329, which is hereby incorporated herein in its entirety. In some embodiments, the physical block can be made of BruxZir material.

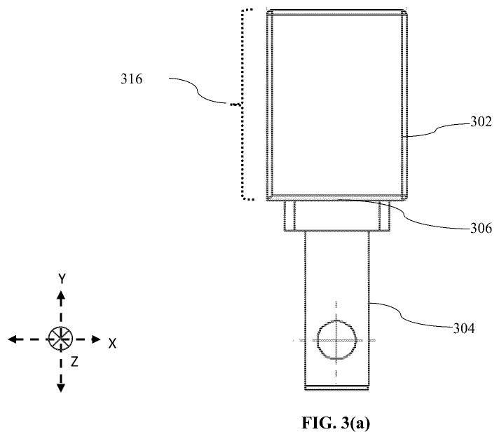

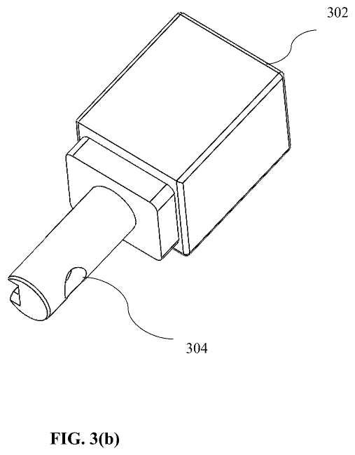

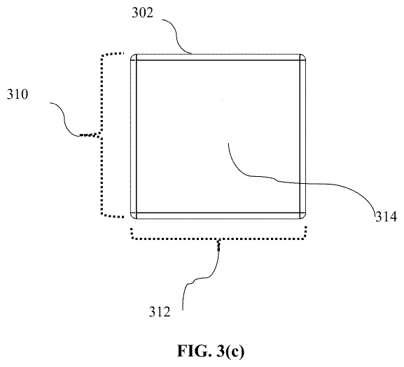

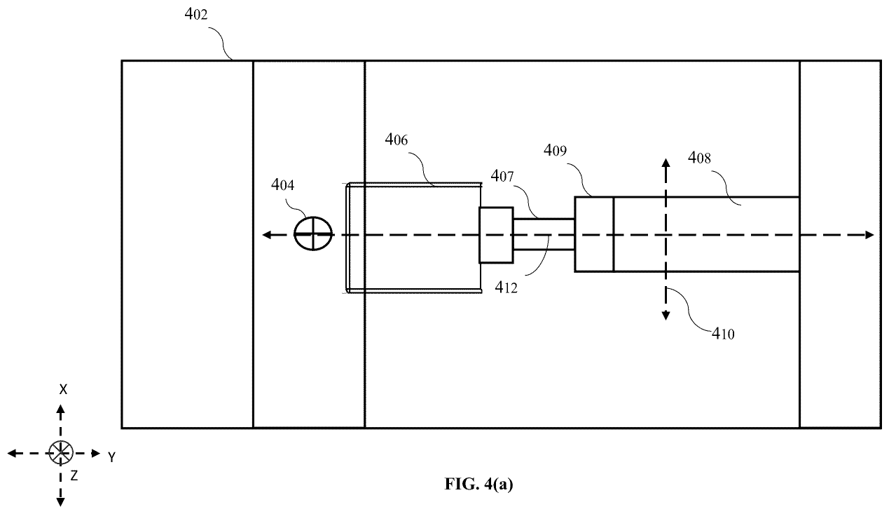

FIG. 3(a), FIG. 3(b), and FIG. 3(c) illustrate different views of an example of a physical block 302 attached to a mandrel 304 with an adhesive such as glue 306. The mandrel 304 can be attached to an arm in the milling machine that can move the physical block 302 and attached mandrel 304 in the X-Y plane of the mill during milling. In some embodiments, the physical block 302 can include a physical block width 310 that can be of any suitable value for making a restoration. In some embodiments, the physical block width 310 can be, for example, in the range from 15 mm to 16 mm. In some embodiments, the physical block 302 can include a physical block depth 312 that can be of any suitable value. In some embodiments, the physical block depth 312 can be in the range from 14 mm to 15 mm. Some embodiments can include optional shade engraving 314. In some embodiments, the physical block 302 can include a physical block height 316 that can be of any suitable value. In some embodiments, the physical block height 316 can be in the range from 19 mm to 20 mm. In some embodiments, the block can be cube shaped.

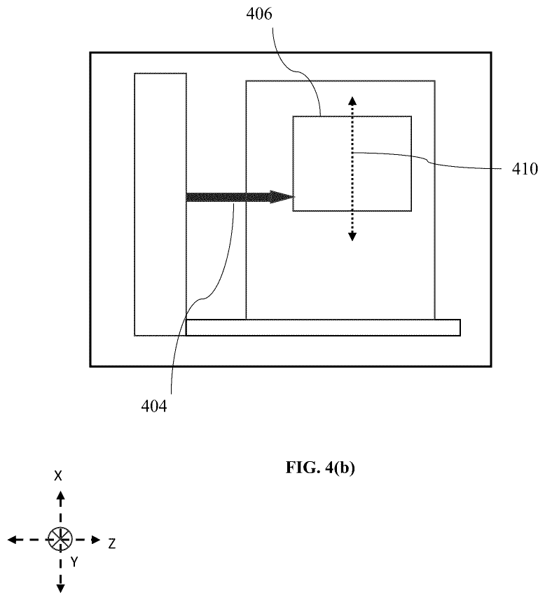

In some embodiments, the physical block can be milled by the milling machine that requires calibration. FIG. 4(a) illustrates a front view and FIG. 4(b) illustrates a side view of an example of a milling machine and mounted physical block used to mill the 3D virtual calibration design into the physical block in some embodiments. As shown in FIG. 4(a) a milling machine 402 can include a milling/grinding tool 404 used to mill physical dental blocks. A physical block 406 can be mounted to a mandrel 407 which can be removably attached to a spring loaded attaching region 409 (such as a clamp) of a milling machine arm 408 that can move along an X-direction/axis 410 and Y-direction 412 and rotate around the Y-axis 412. The milling machine arm 408 can move the physical block 406 in the X-Y plane and rotate the physical block 406 around the Y-axis. The milling/grinding tool 404 can move along the Z-axis 414.

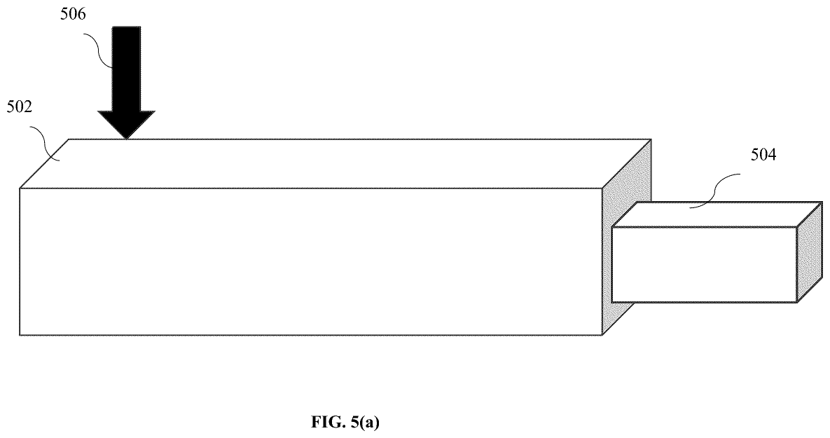

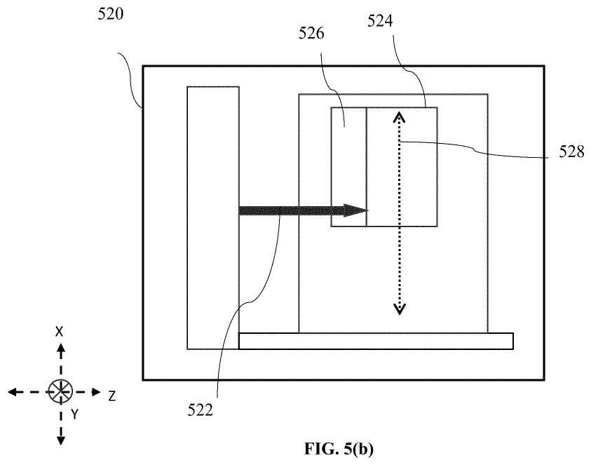

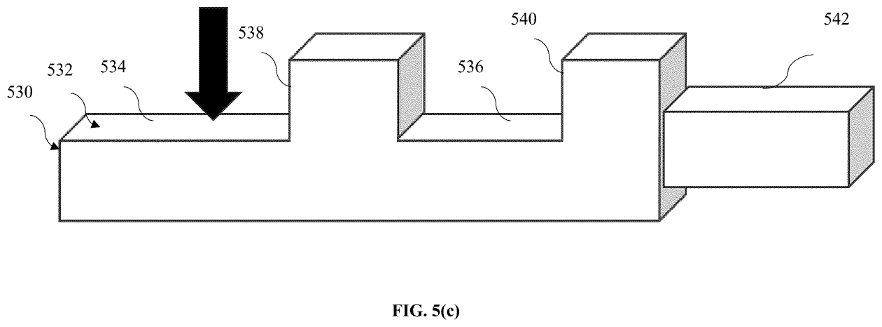

In some embodiments, the calibration routine can mill the 3D virtual calibration design into the physical block to provide a 3D physical milled calibration block. FIG. 5(a) illustrates an example of a physical block 502 with mandrel 504 prior to milling using a milling tool 506 in some embodiments. The milled physical calibration block can include one or more features corresponding to the 3D virtual calibration design. Accordingly, in some embodiments, the physical milled calibration block can include a milled first surface region. In some embodiments, the milled first surface region can include one or more milled indented regions extending into the milled first surface region, and a milled curved region extending from the milled first surface region.

In some embodiments, the designed first surface region can be milled by placing the physical block in a milling machine and lacing the physical block using the milling/grinding tool to reduce the physical block's dimensions. In some embodiments, the milling machine can mill the physical block to provide a milled first section and a milled second section on either side of a middle section. The milled first section can correspond to the designed first section, and the milled second section can correspond to the designed second section as described previously. Accordingly, the milled first section can be furthest from a physical mandrel, and the milled second section can be closest to the physical mandrel, with a middle section in between. In some embodiments, the middle section between the milled first section and milled second section is not milled when milling the first and second sections. Milling of the second section can result in the milled second surface region.

FIG. 5(b) illustrates an example of a milling machine milling 520 using a milling/grinding tool 522 the physical block 524 along the X-direction 528 to provide a first section and the second section separated by a middle section 526.

In some embodiments, the milled first section and the milled second section can be milled to be approximately ½ of the physical block dimensions. In some embodiments, the milled first section and the milled second section can be substantially planar in the X-Y plane, with milling/grinding being performed in the Z direction (depth). In some embodiments, the milling/grinding tool can be placed in a Z position, and the physical block can be moved in the X and Y directions. In some embodiments, the physical block can be moved along the X-direction so that the milling/grinding tool mills the block at a Z depth along the X direction at a fixed Y-position. In some embodiments, the physical block can be moved to the next Y-position and moved along the Y-direction at a depth of Z, for example, skipping milling of the middle section, and only milling the first and second sections. Once the first and second sections have been so milled in the X-Y plane at a fixed depth in Z, the mill can then move the milling/grinding tool along the Z direction to the next Z depth and repeat the milling steps, creating a milled first section, a milled second section, and an unmilled middle section.

In some embodiments, the milled first section can be ½ the depth of the physical block along the Z axis, and the milled second section can also be ½ the depth of the physical block along the Z-axis. In some embodiments, the milled first section and milled second section can be separated by the middle section. In some embodiments, length of the middle section can separate the milled first section and the milled second section along the Y direction. In some embodiments, the middle section can have a length of 4 mm along the Y direction. However, other depths can be milled into the physical block when creating the milled first section and the milled second section, and the middle section can also vary in length as suitable.

FIG. 5(c) illustrates an example in some embodiments, of the physical block 530 with a milled first surface region 532. The milled first surface region 532 can include a milled first section 534 and a milled second section 536 which are separated by middle section 538. Milling of the second section 536 can result in second surface region 540. The milled first section 534 is furthest from mandrel 542, and the milled second section 536 is closest to mandrel 542.

In some embodiments, the one or more designed indented regions can be milled into the physical block to provide one or more milled indented regions in the milled first surface region. In some embodiments, the one or more milled indented regions can be milled into the milled first surface region such as by touching the milled first region with the milling/grinding tool. The milling/grinding tool can be moved along the Z direction, in and out to produce the one or more milled indented regions. The one or more milled indented regions can extend into the milled first surface region. In some embodiments, the one or more designed indented regions can be milled into the milled first section or the milled second section. In some embodiments, the one or more milled indented regions can be created after the milled first section and the milled second section can be created. Accordingly, the one or more milled indented regions can extend into the milled first section or the milled second section. In some embodiments, the milled first section can have three milled indented regions, and the milled second section can have three milled indented regions. However, the number of indented regions can vary as suitable.

In some embodiments, the one or more milled indented regions can be created by extending the tip of the milling/grinding tool into the milled first surface region of the physical block. In some embodiments, the indented regions can be milled per section. For example, in some embodiments, the milled indented regions in the milled first section can be milled one after another, and the milled indented regions in the milled second section can be milled one after another. In some embodiments, the indented regions can be milled in any sequence. In some embodiments, the milled indented regions can be milled into the physical block along a Z direction. In some embodiments, the milled indented regions can be created by extending the tip of the milling/grinding tool half way into the milled first region. Accordingly, each milled indented region can be ½ the diameter of the tip of the milling/grinding tool. In embodiments where the milling/grinding tool has a diameter of 3 mm, for example, each milled indented region can have a diameter of 1.5 mm and also be 1.5 mm in depth along the Z direction from the milled first surface region. In some embodiments, the center of a particular milled indented region can be at the milled first surface region. In some embodiments, each milled indented region can be roughly ½ spherical in shape. However, other suitable milling depths and shapes can be used to create the milled indented regions.

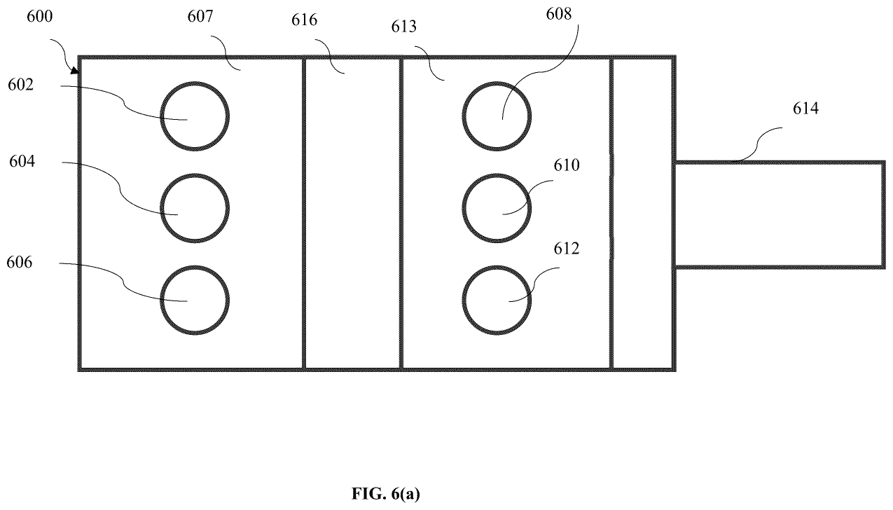

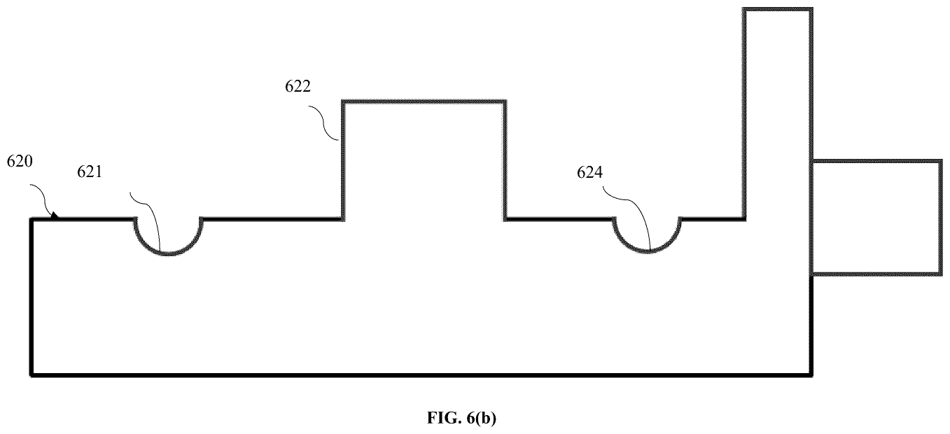

FIG. 6(a) is a front view of an illustration of a physical block after milling one or more indented regions. Milled physical block 600 can include one or more indented regions, such as milled indented regions 602, 604, and 606 in the milled first section 607, and milled indented regions 608, 610, and 612 in the milled section 613. The milled first section 607 is separated from the milled second section 613 by the middle section 616, which at this stage can remain unmilled in some embodiments. The milled first section 607 is furthest from the mandrel 614, and the milled second section 613 is closest to the mandrel 614.

FIG. 6(b) is a side cross section view of an illustration of a physical block after milling one or more indented regions. As can be seen in the figure, the milled first surface 620 can include a milled indented regions 621 and 624, as well as middle section 622.

In some embodiments, the designed curved region can be milled into the block to provide a milled curved region. In some embodiments, milling machine can mill the curved region before or after milling the first surface region and/or the one or more indented regions. In some embodiments, the milled curved region can be created after the first surface region is milled. In some embodiments, the milled curved region can be created after the first surface region and the one or more indented regions are milled, for example after the milled first surface region and the one or more milled indented regions are milled. In some embodiments, the computer-implemented method can first mill the first surface region to provided a milled first surface region, then mill one or more indented regions into the milled first surface region to provide one or more milled indented regions, and then mill the curved region to provide a milled curved region. In some embodiments, the computer-implemented method can first mill the first surface region to provide a milled first surface region, then mill the curved region to provide a milled curved region, and then mill one or more indented regions into the milled first surface region to provide one or more milled indented regions. In some embodiments, milling the first surface region, the one or more indented regions, and the curved region can be performed in any order.

In some embodiments, the calibration routine can include milling a curved region into the physical block. In some embodiments, the curved region can be milled by setting the milling tool at a fixed Z-position and rotating the physical block 180 degrees around the Y-axis, then moving the block in a Y-direction by a small distance (such as microns, in some embodiments), rotating the physical block back 180 degrees with the milling tool a fixed Z distance to mill another curve into the block, and repeating the process until a desired height in the Y-direction is achieved. In this manner, the calibration routine can mill a curved region at a fixed radius from the center of the physical block and having a height in the Y-direction. In some embodiments, the curved region can be milled by setting the milling/grinding tool at a Z-position and milling the curved region by rotating the physical block back and forth by 180 degrees and moved in the Y direction so that the a curved cylinder radius is 6.0 mm. The milling/grinding tool can then be moved in the Z direction and the physical block rotated back and forth by 180 degrees and moved in the Y direction so that the curved region radius is 5.5 mm. The milling/grinding tool can then be moved in the Z direction and the physical block rotated back and forth by 180 degrees and moved in the Y direction so that the curved region radius is 5 mm. As discussed previously, the height (along the Y-axis) of the milled curved region can be 4 mm in some embodiments. Other suitable radii and height values can be used to mill the curved region into the physical block.

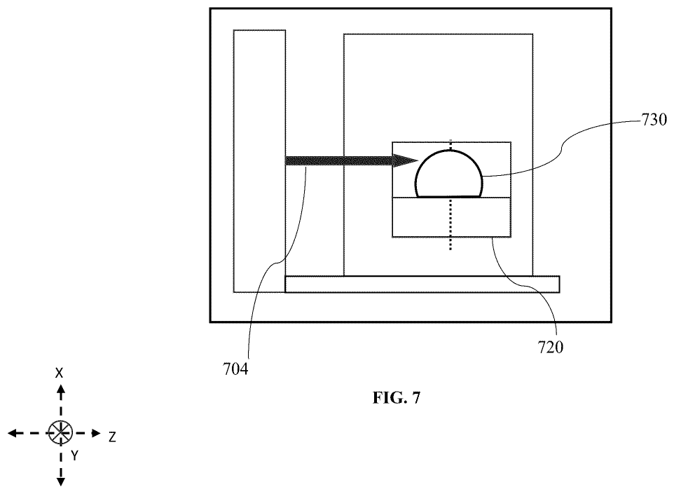

FIG. 7 illustrates an example of the calibration routine milling a curved region 730 by rotating the physical block 720 while maintaining the milling tool 704 at a fixed position in the Z-direction and the X-direction. In some embodiments, milling can include rotating the physical block 720 by 180 degrees around the Y-axis back and forth, moving the block in the Y-direction with each rotation to generate a curved region such as a half cylinder at a particular Z position (depth). For example, in some embodiments, the milling tool can be moved into the physical block 720 and held at an initial position of 6.0 mm from the center of the physical block 720 and then rotate the physical block 720 around a Y-axis from 0 degrees to 180 degrees. The physical block 720 can then be moved in the Y-direction and rotate back from 180 degrees to 0 degrees. This process can be repeated until the curved region at the desired curved region height is milled. The milling tool can then be moved into the physical block 720 and held at a second position of 5.5 mm from the center of the physical block 720 and then rotate the physical block 720 around a Y-axis from 0 degrees to 180 degrees. The physical block 720 can then be moved in the Y-direction and rotate back from 180 degrees to 0 degrees. This process can be repeated until the curved region at the desired curved region height is milled. The milling tool can be moved into the physical block 720 and held at an initial position of 5.0 mm from the center of the physical block 720 and then rotate the physical block 720 around a Y-axis from 0 degrees to 180 degrees. The physical block 720 can then be moved in the Y-direction and rotate back from 180 degrees to 0 degrees. This process can be repeated until the curved region at the desired curved region height is milled.

Some embodiments can include milling the block based on the 3D virtual calibration design to provide a 3D physical milled calibration block as part of performing calibration on the milling machine. In some embodiments, milling the block can include following the calibration routine as described herein.

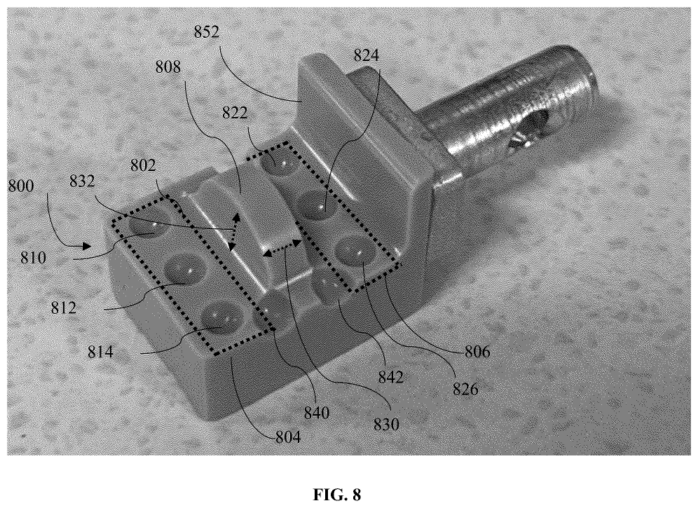

FIG. 8 illustrates a 3D physical milled calibration block 800 in some embodiments after milling is complete. The 3D physical milled calibration block 800 can include a milled first surface 802 and a second surface 852. The milled first surface 802 can include a milled first section 804, a milled second section 806, and a milled curved region 808. The milled curved 808 can include a milled curved region radius 832 and a milled curved region height 830. The milled first section 804 can include one or more milled indented regions such as milled indented region 810, milled indented region 812, and milled indented region 814. The milled second section 806 can include milled indented region 822, milled indented region 824, and milled indented region 826. The 3D physical milled calibration block 800 can optionally include additionally milled indented regions such as milled indented region 840 and milled indented region 842 that can help an intraoral scanner generate a 3D scanned model.

In some embodiments, the 3D physical milled calibration block can be scanned to provide a 3D scanned model of a milled calibration block (also referred to as a “virtual calibration block scan”). In some embodiments, the 3D scanned model of the milled calibration block be a point cloud. The 3D scanned model of the milled calibration block can include a scanned first surface region corresponding to the designed first region, one or more scanned indented regions corresponding to one or more designed indented regions, and a scanned curved region corresponding to the designed curved region.

In some embodiments, the 3D physical milled calibration block can be removed from the mill after milling is complete and placed in a 3D scanner for scanning. In some embodiments, the scanner can be a surface scanner. In some embodiments, the front of the 3D physical milled calibration block is scanned to provide a 3D scanned model of the milled calibration block of the 3D physical milled calibration block. In some embodiments, the scanner can scan in 3D, thereby capturing curvature and depth, including curvature of the curved region. The scanner can be any type of scanner known in the art that can generate a 3D scanned model of the 3D physical milled calibration block. In some embodiments, the 3D calibration block scan be in the form a point cloud. In some embodiments, the 3D calibration block scan can include a bounding box that indicates the boundary of the scan. In some embodiments, the 3D physical milled calibration block is placed in the scanner at a known orientation.

In some embodiments, the 3D scanner can be a intraoral scanner, such as one used in a dentist's office, for example. The 3D physical milled calibration block can be scanned by an intraoral scanner. In some embodiments, the intraoral scanner can be handheld, for example. In some embodiments, the intraoral scanner can scan the 3D physical milled calibration block at any orientation to produce a 3D scanned model of the milled calibration block.

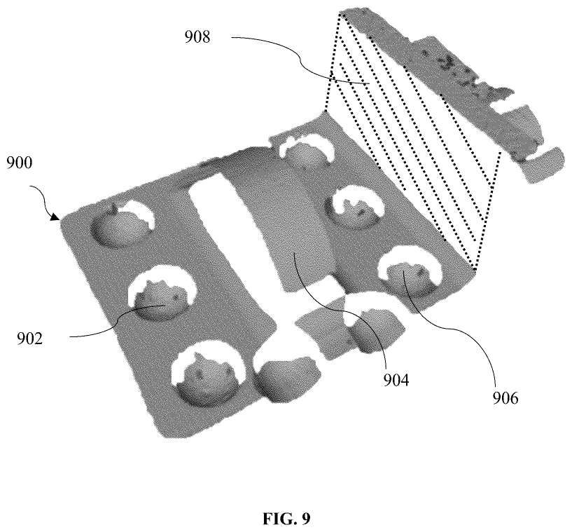

FIG. 9 illustrates a 3D scanned model of the milled calibration block 900 in some embodiments. The 3D scanned model of the milled calibration block 900 includes one or more scanned indented regions such as scanned indented region 902 is a scanned first section and scanned indented region 906 in the scanned second section of the scanned first surface. Also include in the 3D scanned model of the milled calibration block 900 is a scanned curved region 904 and scanned second surface region 908.

In some embodiments, the computer-implemented method can receive the 3D scanned model of the milled calibration block as part of performing calibration for the milling machine. In some embodiments, the computer-implemented method can register the virtual calibration block scan with the 3D virtual calibration design model. Since both the 3D virtual calibration design model and the 3D scanned model of the milled calibration block are point clouds, the computer-implemented method can perform point cloud registration as is known in the art. For example, in some embodiments, the computer-implemented method can perform iterative closest point registration as is known in the art. In the case of a stationary 3D scanner in which the 3D physical calibration block is placed at a known orientation, the computer-implemented method can perform registration using any technique known in the art based on the one or more indented regions appearing in the 3D scanned model of the milled calibration block and in the 3D virtual calibration design model. In the case of an intraoral scanner, where a particular orientation is not guaranteed, the computer-implemented method can perform registration between the 3D virtual calibration design model and the 3D scanned model of the milled calibration block using the one or indented regions and the second surface region. The second surface region can be in a different plane than the first surface region. For example, in some embodiments, the computer-implemented method can use the second surface region attached to the mandrel as an additional feature for registration.

In some embodiments, the computer-implemented method can determine a bounding box that includes virtual scanned versions of the first surface region, the second surface region, and the curved region.

In some embodiments, the computer-implemented method can determine one or more calibration parameter offsets for the milling machine based on the 3D scanned model of the milled calibration block. In some embodiments, the one or more calibration parameter offsets can include an X-offset, a Z-offset, squareness, rotation axis offset, X scale, and Y scale.

In some embodiments, the computer-implemented method can determine the one or more calibration offsets based on the scanned first surface region, the one or more scanned indented regions, and/or the scanned curved region.

In some embodiments, the computer-implemented method can determine one or more calibration offsets based on the one or more scanned indented regions. In some embodiments, the computer-implemented method can determine a center for each of the one or more scanned indented regions. The computer-implemented method can project a ray from the center of a particular designed indented region in the registered 3D virtual calibration design model and determine where on the scanned indented region the projected ray intersects. The computer-implemented method can then construct a sphere whose center is at the intersection point on the scanned indented region and whose radius is less than the radius of the designed indented region. The computer-implemented method can then determine a 3D curve of points belonging to the scanned indented region that fall within the constructed sphere. The computer-implemented method can then from the 3D curve of points construct a second sphere using the best fit algorithm known in the art. The computer-implemented method can then determine the center of the second sphere as the center of the particular scanned indented region. In some embodiments, the computer-implemented method can determine the center of each of the scanned indented regions, or a subset of the scanned indented regions in this manner. In some embodiments, the centers of each of the scanned indented regions are scanned indented region center points with Xn, Yn coordinates, with n=1 to the number of scanned indented regions. In some embodiments, n=1 to 6.

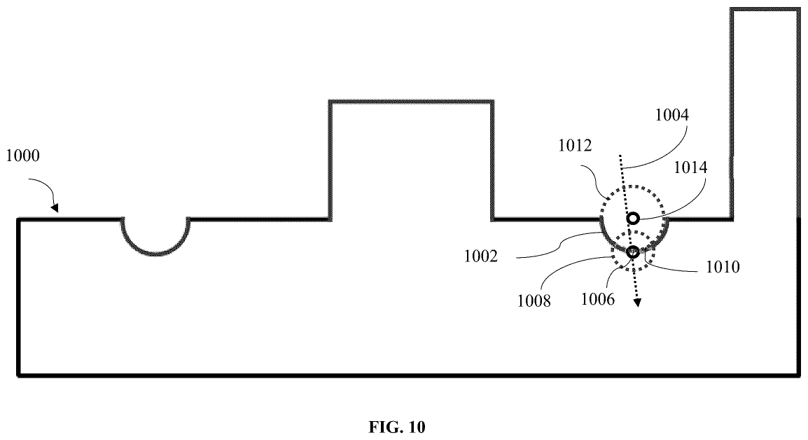

FIG. 10 illustrates a cross sectional side view of a 3D scanned model of the milled calibration block 1000 with a scanned indented region 1002. The computer-implemented method can project a ray 1004 from the center of a particular designed indented region in the registered 3D virtual calibration design model and determine an intersection point 1006 of the ray 1004 on the scanned indented region 1002. The computer-implemented method can then construct a sphere 1008 whose center is at the intersection point 1006 on the scanned indented region 1002 and whose radius is less than the radius of the designed indented region. The computer-implemented method can then determine a 3D curve of points 1010 belonging to the scanned indented region 1002 that fall within the constructed sphere 1008. The computer-implemented method can then from the 3D curve of points 1010 construct a second sphere 1012 using the best fit algorithm known in the art. The computer-implemented method can then determine the center 1014 of the second sphere 1012 as the center of the particular scanned indented region 1002. In some embodiments, the computer-implemented method can determine the center of each of the scanned indented regions, or a subset of the scanned indented regions in this manner.

In some embodiments, the computer-implemented method can determine the scanned curved region in the virtual calibration block scan. In some embodiments, the computer-implemented method can determine an approximate location of the scanned curved region in the 3D virtual calibration scan based on the location of the designed curved region in the registered 3D virtual calibration design model. In some embodiments, the computer-implemented method can utilize dimensions smaller than the designed curved region to determine the scanned curved region. In some embodiments, the computer-implemented method can determine at least a portion of the scanned region based on the designed curved region. In some embodiments, the computer-implemented method can determine a best fit cylinder to the at least portion of the scanned curved region to obtain the radius, center, and axis of the cylinder using best fit techniques known in the art and determine the fitted cylinder's radius.

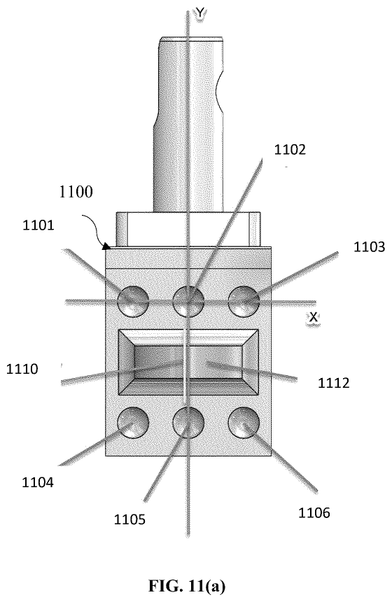

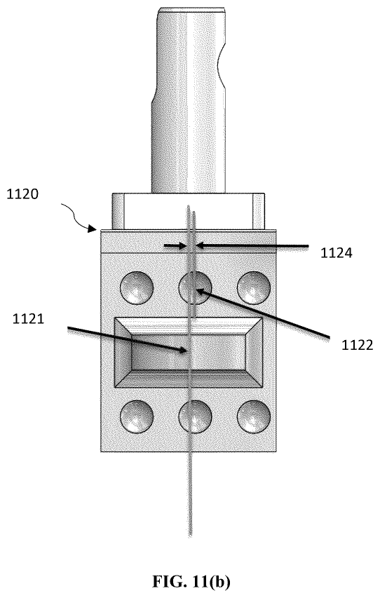

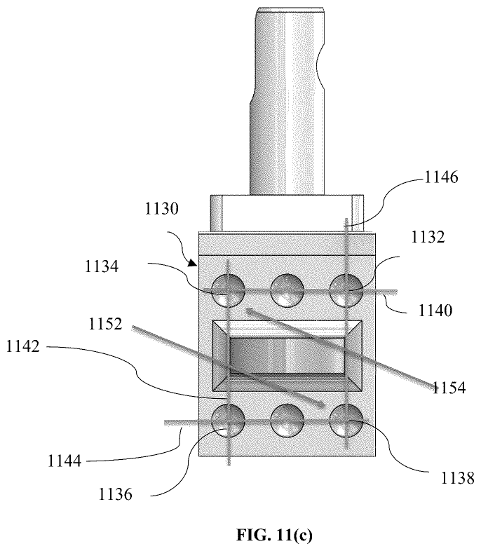

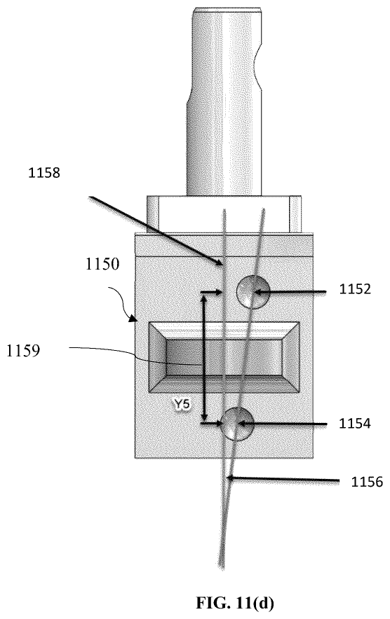

FIG. 11(a) illustrates 3D scanned model of the milled calibration block 1100. The 3D scanned model of the milled calibration block 1100 can include a first scanned indented region 1101 having center coordinates of (x1, y1), a second scanned indented region 1102 having center coordinates of (x2, y2), a third scanned indented region 1103 having center coordinates (x3, y3), a fourth scanned indented region 1104 having center coordinates (x4, y4), a fifth scanned indented region 1105 having center coordinates (x5, y5), and a sixth scanned indented region 1106 having center coordinates (x6, y6). The 3D scanned model of the milled calibration block 1100 can also have a cylinder axis 1110, and a scanned cylinder radius for a scanned cylinder region 1112. This naming convention applies to FIG. 11(b), FIG. 11(c), and FIG. 11(d).

In some embodiments, the computer-implemented method can determine the X offset as the distance from the cylinder axis to the center point of a scanned middle indented region. In some embodiments, the scanned middle indented region can be located in the scanned first section. In some embodiments, the scanned middle indented region can be in the scanned second section (the portion closest to the mandrel) of the scanned first surface region. In some embodiments, the computer-implemented method can determine the Z offset as the designed curved region radius minus the scanned cylinder radius.

FIG. 11(b) illustrates 3D scanned model of the milled calibration block 1120 with scanned middle indented region 1122 whose center axis in the X-Y plane 1124 is offset by a distance from the cylinder axis 1121 to provide the X-offset; The Z offset can be determined as the designed cylinder radius minus the scanned cylinder radius.

In some embodiments, the computer-implemented method can determine squareness in the XY plane. The computer-implemented method can determine squareness in the XY plane by passing lines through scanned indented region center points of corner indented regions, and determining squareness in the XY plane based on the angle of their intersection in some embodiments. In some embodiments, the computer-implemented method can pass a first line through the two scanned indented region center points located in the corners of the scanned second section. In some embodiments, the computer-implemented method can pass a second line through scanned corner indented region center points located in the corners of their respective section on a first side of the scanned first surface region. In some embodiments, the computer-implemented method can pass a third line through the two scanned indented region center points located in the corners of the scanned first section. In some embodiments, the computer-implemented method can pass a fourth line through two scanned corner indented region center points located in the corners of their respective section on a second side of the scanned first surface region. In some embodiments, the computer-implemented method can then determine the XY squareness as the average of an angle between the first line and second line and an angle between the second line and the third line. In some embodiments, the computer-implemented method can determine the slopes of the first, second, third and fourth lines. In some embodiments, the computer-implemented method can determine a first angle between the first line and the second line, and a second angle between the third line and the fourth line. In some embodiments, the computer-implemented method can determine the squareness in the XY plane as the average of the first angle and the second angle.

FIG. 11(c) illustrates 3D scanned model of the milled calibration block 1130 with first scanned corner indented region 1132, second scanned corner indented region 1134, third scanned corner indented region 1136, and fourth scanned corner indented region 1138. The computer-implemented method can construct a first line 1140 connecting the center points of the first scanned corner indented region 1132 and the second scanned corner indented region 1134. The first scanned corner indented region 1132 and the second scanned corner indented region 1134 are in the same section, scanned second section. The computer-implemented method can then construct a second line 1142 connecting the center points of the second scanned corner indented region 1134 and the third scanned corner indented region 1136. The second scanned corner indented region 1134 and the third scanned corner indented region 1136 are in different sections but on one side of the scanned first surface region. The computer-implemented method can then construct a third line 1144 connecting the center points of the third scanned corner indented region 1136 and the fourth scanned corner indented region 1138. The third scanned corner indented region 1136 and the fourth scanned corner indented region 1138 are in the same section (scanned first section). The computer-implemented method can then construct a fourth line 1146 connecting the center points of the fourth scanned corner indented region 1138 and the first scanned corner indented region 1132. The fourth scanned corner indented region 1138 and the first scanned corner indented region 1132 are in different sections but on a second side of the scanned first surface region.

In some embodiments, the computer-implemented method can determine squareness as follows:
line 1 passes through the points (x2, y2) and (x3, y3);
line 2 passes through the points (x2, y2) and (x5, y5);
line 3 passes through the points (x4, y4) and (x5, y5);
XY squareness 1=Angle between line 1 and 2;
XY squareness 2=Angle between line 2 and 3;
Use average of two values;
L1 slope: m1=(y3−y1)/(x3−x1);
L2 slope: m2=(y4−y1)/(x4−x1)
L3 slope: m3=(y4−y6)/(x4−x6)
L4 slope: m4=(y3−y6)/(x3−x6)
L1, L2 angle: A1=ATN(ABS((m1−m2)/(1+m1*m2)))
L3, L4 angle: A2=ATN(ABS((m2−m3)/(1+m2*m3)))
Squareness=Average (A1, A2)

FIG. 11(c) illustrates angle A1 1154, and angle A2 1152. In some embodiments, the computer-implemented method can determine a rotary axis offset angle (A). In some embodiments, the computer-implemented method can determine rotary axis offset angle based on the angle of a line formed going through a scanned middle indented region in the scanned first section and a scanned middle indented region in the scanned second section and the cylinder axis. In some embodiments, the actual rotation axis can be the half cylinder axis.

FIG. 11(d) illustrates a 3D scanned model of the milled calibration block 1150 with scanned middle indented region 1152 (corresponding to the second scanned indented region) in the first scanned section and scanned middle indented region 1154 (corresponding to the fifth scanned indented region) in the second scanned section as well as cylinder axis 1158. In some embodiments:

A=A TAN((x2−x5)/y5);

Rotation Axis Offset (Degree)=A*180/3.141592
where y is a distance 1159 along the Y-axis between the center points of the second scanned indented region 1152 and the fifth scanned indented region 1154. FIG. 11(d) illustrates A as 1156.

In some embodiments, the computer-implemented method can determine X scale and Y scale based on the designed distances in the 3D virtual calibration design model and the scanned indented region center points. In some embodiments, the X scale can be determined based on the distance in the X direction between a center scanned indentation region and a corner scanted indentation region in the scanned first section and on the distance in the X direction between a center scanned indentation region and a corner scanted indentation region in the scanned second section. In some embodiments, the Y scale can be determined based on distances along the Y direction between the center scanned indentation region center point in the scanned first section and the center scanned indentation region center point in the scanned second section. In some embodiments, X scale can be determined as follows:

XScale=(ABS(x2−x3)+ABS(x5−x4))/2/Designed Distance X;

In some embodiments, Y scale can be determined as follows:

YScale=ABS(y5−y2)/Designed Distance Y.

In some embodiments, one or more calibration values can be sent to the cloud. In some embodiments, the computer-implemented method can update milling production instructions for the milling machine generating the calibration alert by applying the calibration values. In some embodiments, the update can be applied to mill's configuration/offsets remotely. In some embodiments, the update can be applied through the cloud computing environment. In some embodiments, the mill can be located in a dental office, and calibration values can be determined in and/or through the cloud computing environment, and the mill located in the dental office can be updated remotely with the calibration values. In some embodiments, one or more of the calibration values can be applied only if out of tolerance. In some embodiments, the Z-axis tolerance is within +/−50 microns. In some embodiments, the X-axis tolerance is within +/−20 microns. In some embodiments, the Y-axis tolerance can be +/−2 mm. In some embodiments, the X-offset and the Z-offset can be applied even if the axes are within their respective tolerances.

Some embodiments can include one or more features in various combinations. Some embodiments can include a computer-implemented method of automated milling machine calibration that can include receiving a 3D virtual calibration design comprising one or more designed indented regions and a designed curved region; milling the 3D virtual calibration design into a physical block to provide a 3D physical milled calibration block; receiving a 3D virtual calibration scan block of the 3D physical milled calibration block; and determining one or more calibration parameters from the 3D virtual calibration scan block

The method can include receiving a calibration alert from a milling machine, wherein the milling is performed by the calibration alert generating milling machine. The method can include updating milling production instructions with the one or more calibration parameters. The milling production instructions can be updated automatically. Milling the 3D virtual calibration design into the physical block can include milling a first section of a first surface region and a second section of the first surface region into the physical block. The method of claim 5, wherein milling the 3D virtual calibration design comprises milling a curved region into the physical block to provide a milled curved region between the first section and the second section. Milling the 3D virtual calibration design can include milling one or more designed indented regions into the first section and the second section to provide one or more milled indented regions. In some embodiments, the method can be executed by a processor executing instructions as part of a system. In some embodiments, the method can be stored as instructions on non-transitory computer-readable storage medium.

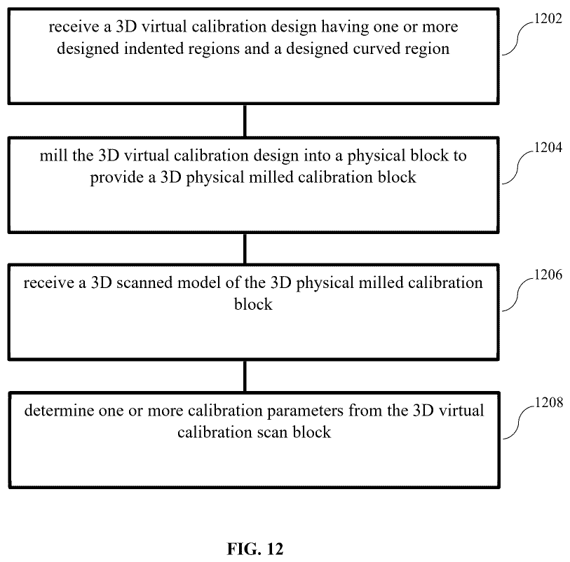

FIG. 12 illustrates one or more features. The computer-implemented method/system can receive a 3D virtual calibration design having one or more designed indented regions and a designed curved region at 1202, mill the 3D virtual calibration design into a physical block to provide a 3D physical milled calibration block at 1204, receive a 3D virtual calibration scan block of the 3D physical milled calibration block at 1206, and determine one or more calibration parameters from the 3D virtual calibration scan block at 1208.

One or more advantages of one or more features in some embodiments can include, for example, detecting and correcting for misalignment of one or more milling axes. One or more advantages of one or more features in some embodiments can include, for example, accounting for misalignment caused by vibrations and resistive forces a CNC machine encounters. One or more advantages of one or more features in some embodiments can include, for example, quality of milled objects after automatic alignment. One or more advantages of one or more features in some embodiments can include, for example, quality of milling objects such as dental prosthesis. One or more advantages of one or more features in some embodiments can include, for example, automated milling calibration measurement. One or more advantages of one or more features in some embodiments can include, for example, precise milling calibration measurement. One or more advantages of one or more features in some embodiments can include, for example, fast calibration. One or more advantages can include being able to use an intraoral scanner. One or more advantages can include, for example, determining mill calibration requirements and performing mill calibration remotely, through a cloud computing environment allowing for mill calibration without physically accessing the mills spread out in different dental offices.

Some embodiments include a processing system for milling calibration, including: a processor, a computer-readable storage medium including instructions executable by the processor to perform steps including: receiving a calibration alert from a milling machine; performing automated calibration on the milling machine to determine one or more offsets; and automatically updating milling production instructions with the one or more offsets.

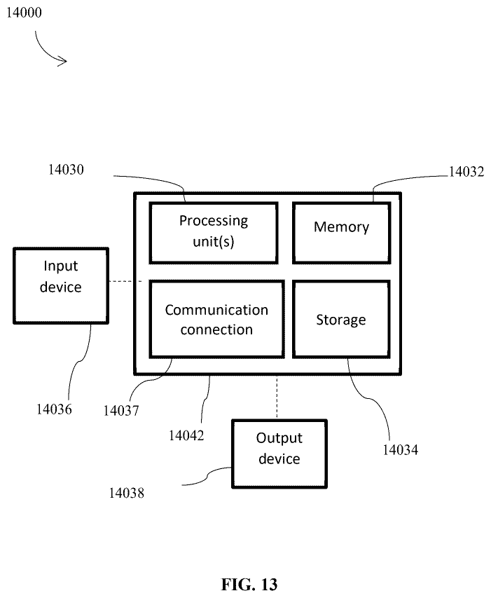

FIG. 13 illustrates a processing system 14000 in some embodiments. The system 14000 can include a processor 14030, computer-readable storage medium 14034 having instructions executable by the processor to perform one or more steps described in the present disclosure.

In some embodiments the computer-implemented method can display a digital model on a display and receive input from an input device such as a mouse or touch screen on the display for example. The computer-implemented method can, upon receiving manipulation commands, rotate, zoom, move, and/or otherwise manipulate the digital model in any way as is known in the art. In some embodiments, the digital models can be CAD models.

One or more of the features disclosed herein can be performed and/or attained automatically, without manual or user intervention. One or more of the features disclosed herein can be performed by a computer-implemented method. The features-including but not limited to any methods and systems-disclosed may be implemented in computing systems. For example, the computing environment 14042 used to perform these functions can be any of a variety of computing devices (e.g., desktop computer, laptop computer, server computer, tablet computer, gaming system, mobile device, programmable automation controller, video card, etc.) that can be incorporated into a computing system comprising one or more computing devices. In some embodiments, the computing system may be a cloud-based computing system.

For example, a computing environment 14042 may include one or more processing units 14030 and memory 14032. The processing units execute computer-executable instructions. A processing unit 14030 can be a central processing unit (CPU), a processor in an application-specific integrated circuit (ASIC), or any other type of processor. In some embodiments, the one or more processing units 14030 can execute multiple computer-executable instructions in parallel, for example. In a multi-processing system, multiple processing units execute computer-executable instructions to increase processing power. For example, a representative computing environment may include a central processing unit as well as a graphics processing unit or co-processing unit. The tangible memory 14032 may be volatile memory (e.g., registers, cache, RAM), non-volatile memory (e.g., ROM, EEPROM, flash memory, etc.), or some combination of the two, accessible by the processing unit(s). The memory stores software implementing one or more innovations described herein, in the form of computer-executable instructions suitable for execution by the processing unit(s).

A computing system may have additional features. For example, in some embodiments, the computing environment includes storage 14034, one or more input devices 14036, one or more output devices 14038, and one or more communication connections 14037. An interconnection mechanism such as a bus, controller, or network, interconnects the components of the computing environment. Typically, operating system software provides an operating environment for other software executing in the computing environment, and coordinates activities of the components of the computing environment.

The tangible storage 14034 may be removable or non-removable, and includes magnetic or optical media such as magnetic disks, magnetic tapes or cassettes, CD-ROMs, DVDs, or any other medium that can be used to store information in a non-transitory way and can be accessed within the computing environment. The storage 14034 stores instructions for the software implementing one or more innovations described herein.

The input device(s) may be, for example: a touch input device, such as a keyboard, mouse, pen, or trackball; a voice input device; a scanning device; any of various sensors; another device that provides input to the computing environment; or combinations thereof. For video encoding, the input device(s) may be a camera, video card, TV tuner card, or similar device that accepts video input in analog or digital form, or a CD-ROM or CD-RW that reads video samples into the computing environment. The output device(s) may be a display, printer, speaker, CD-writer, or another device that provides output from the computing environment.

The communication connection(s) enable communication over a communication medium to another computing entity. The communication medium conveys information, such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Any of the disclosed methods can be implemented as computer-executable instructions stored on one or more computer-readable storage media 14034 (e.g., one or more optical media discs, volatile memory components (such as DRAM or SRAM), or nonvolatile memory components (such as flash memory or hard drives)) and executed on a computer (e.g., any commercially available computer, including smart phones, other mobile devices that include computing hardware, or programmable automation controllers) (e.g., the computer-executable instructions cause one or more processors of a computer system to perform the method). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media 14034. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, Python, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

In view of the many possible embodiments to which the principles of the disclosure may be applied, it should be recognized that the illustrated embodiments are only examples and should not be taken as limiting the scope of the disclosure.

What is claimed is:

1. A computer-implemented method of automated milling machine calibration, comprising:
receiving a 3D virtual calibration design comprising one or more designed indented regions and a designed curved region;
milling the 3D virtual calibration design into a physical block to provide a 3D physical milled calibration block;
receiving a 3D virtual calibration scan block of the 3D physical milled calibration block; and
determining one or more calibration parameters from the 3D virtual calibration scan block.

2. The method of claim 1, further comprising receiving a calibration alert from a milling machine, wherein the milling is performed by the calibration alert generating milling machine.

3. The method of claim 1, further comprising updating milling production instructions with the one or more calibration parameters.

4. The method of claim 3, wherein the milling production instructions are updated automatically.

5. The method of claim 1, wherein milling the 3D virtual calibration design into the physical block comprises milling a first section of a first surface region and a second section of the first surface region into the physical block.

6. The method of claim 5, wherein milling the 3D virtual calibration design comprises milling a curved region into the physical block to provide a milled curved region between the first section and the second section.

7. The method of claim 5, wherein milling the 3D virtual calibration design comprises milling one or more designed indented regions into the first section and the second section to provide one or more milled indented regions.

8. A non-transitory computer readable medium storing executable computer program instructions to provide automated milling machine calibration, the computer program instructions comprising instructions for:
receiving a 3D virtual calibration design comprising one or more designed indented regions and a designed curved region;
milling the 3D virtual calibration design into a physical block to provide a 3D physical milled calibration block;
receiving a 3D virtual calibration scan block of the 3D physical milled calibration block; and
determining one or more calibration parameters from the 3D virtual calibration scan block.

9. The medium of claim 8, further comprising receiving a calibration alert from a milling machine, wherein the milling is performed by the calibration alert generating milling machine.

10. The medium of claim 8, further comprising updating milling production instructions with the one or more calibration parameters.

11. The medium of claim 8, wherein milling the 3D virtual calibration design into the physical block comprises milling a first section of a first surface region and a second section of the first surface region into the physical block.

12. The medium of claim 11, wherein milling the 3D virtual calibration design comprises milling a curved region into the physical block to provide a milled curved region between the first section and the second section.

13. The medium of claim 12, wherein milling the 3D virtual calibration design comprises milling one or more designed indented regions into the first section and the second section.

14. A system for calibrating a mill, the system comprising:
a processor; and
a non-transitory computer-readable storage medium comprising instructions executable by the processor to perform steps comprising:
receiving a 3D virtual calibration design comprising one or more designed indented regions and a designed curved region;
milling the 3D virtual calibration design into a physical block to provide a 3D physical milled calibration block;
receiving a 3D virtual calibration scan block of the 3D physical milled calibration block; and
determining one or more calibration parameters from the 3D virtual calibration scan block.

15. The system of claim 14, further comprising receiving a calibration alert from a milling machine, wherein the milling is performed by the calibration alert generating milling machine.

16. The system of claim 15, further comprising updating milling production instructions with the one or more calibration parameters.

17. The system of claim 16, wherein the milling production instructions are updated automatically.

18. The system of claim 15, wherein milling the 3D virtual calibration design into the physical block comprises milling a first section of a first surface region and a second section of the first surface region into the physical block.

19. The system of claim 18, wherein milling the 3D virtual calibration design comprises milling a curved region into the physical block to provide a milled curved region between the first section and the second section.

20. The system of claim 19, wherein milling the 3D virtual calibration design comprises milling one or more designed indented regions into the first section and the second section to provide one or more milled indented regions.
